(19) United States
(12) Patent Application Publication
(10) Pub. No.: US 2004/0059639 A1
(43) Pub. Date: Mar. 25, 2004

(54) Sales computer system and process

(76) Inventors: Walter Vernon Ripper, Caulfield South, Victoria (AU); Mark William Brooks, Heidelberg Heights, Victoria (AU); Graham Andrew Pitson, Ascot Vale, Victoria (AU)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/432,804

(22) PCT Filed: Nov. 27, 2001
(86) PCT No.: PCT/AU01/01534

(30) Foreign Application Priority Data
Nov. 27, 2000 (AU) PR 1665

(51) Int. Cl. G06F 17/60

(52) U.S. Cl. 705/26; 705/1; 705/4

(57) ABSTRACT

A sales process, executed by a computer system, including (a) offering a plurality of products for sale, (b) receiving a selection of the products, (c) accessing data submission forms for products of the selection, (d) removing duplicate data requests from the forms, and (e) generating and providing a sequence of forms for the selection. Customer data submitted using the sequence is received, and a cost generated for the selection on the basis of the customer data. The process facilitates execution of a contract, generated on the basis of the customer data for sale of the selection cost. The process is adapted to apply different product supplier schemes having different underwriting and commission structures.

The present invention relates to a sales computer system and process, and in particular to a sales process for dynamically generating forms for the sale of different products, such as finance and issuance products, and dynamically adjusting the quote for the sale.

Most point of sale computer systems have been developed to sell a specific service or product. For example, a computer system that has been developed for car finance is not also able to sell house insurance. In many cases, the data entry screens and business rules associated with a product or service are hard-coded and product/service specific and, as such, the sequence in which data is collected is inflexible. Further, existing sales methods inhibit the sale of products to a client across industries without data duplication. For example, in the financial services industry separate data collection, calculations and underwriting requirements exist for life insurance products, general insurance products, finance products and investment products and yet core client details and financial information are common to all of the products. Accordingly, it is desired to provide a sales process and system which addresses at least one of these problems or at least provides a useful alternative.

In accordance with the present invention there is provided a sales computer system including:

a product selector for offering a plurality of products for sale and receiving a selection of said products; and

a form generator responsive to said selection for accessing data submission forms for the products of said selection, and generating and providing a sequence of forms for said selection.

The present invention also provides a sales process, executed by a computer system, including:

offering a plurality of products for sale;

receiving a selection of said products;

accessing data submission forms for products of said selection;

removing duplicate data requests from said forms; and

generating and providing a sequence of forms for said selection.

The present invention also provides a sales process, executed by a computer system, including:

dynamically generating a sequence of data submission forms for sale of a selection of different products, such as insurance and finance products, said sequence excluding duplicate data entry requests;

dynamically generating a quote for the products of said selection on submission of the forms of said sequence; and

dynamically generating and publishing at least one contract for sale of said products on acceptance of said quote.

The present invention also provides a sales process, executed by a computer system, for sale of different products, including:

selecting said products;

querying underwriting modules for the products to obtain corresponding business rules;

dynamically constructing client data submission forms for sale of said products on the basis of data from said underwriting modules, said forms removing duplication of data entry;

providing said forms in a sequence based on a user profile; and

extracting and transmitting client data submitted using said sequence to different suppliers of the products in respective formats for the suppliers.

The present invention also provides a sales computer system including:

a form generator responsive to the selection of products for sale for accessing data submission forms for the products of said selection, and generating and providing a sequence of forms for the selection;

a cost module, responsive to customer data submitted using said sequence for generating a cost for the selection; and

a scheme module for applying a predetermined sales scheme to said sequence and said cost.

Preferred embodiments of the present invention are hereinafter described, by way of example only, with reference to the accompanying drawings, wherein:

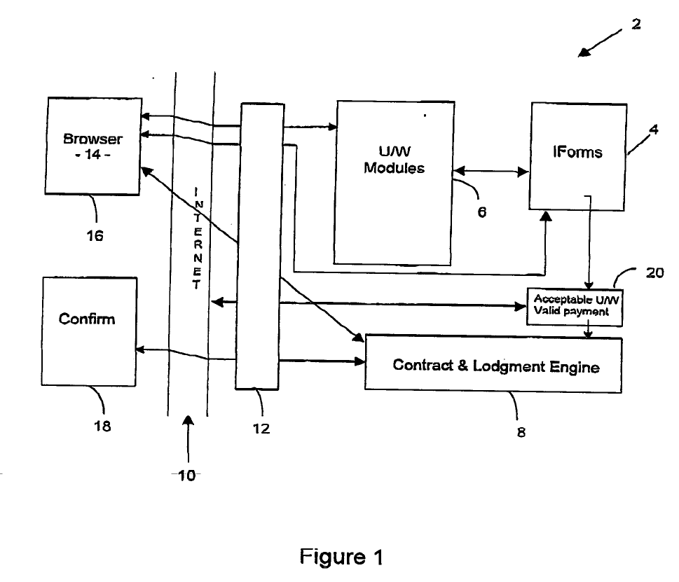

FIG. 1 is a block diagram of a preferred embodiment of a sales computer system connected to a communications network;

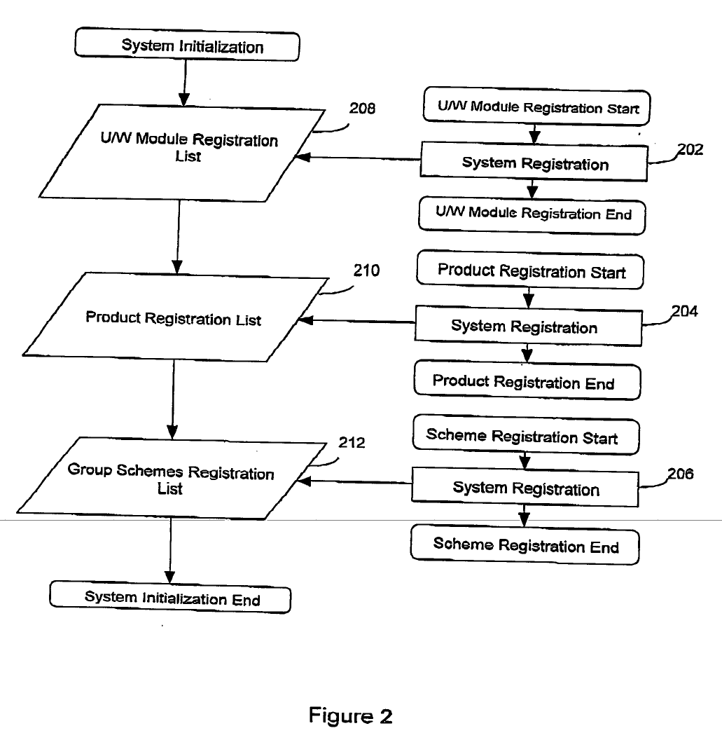

FIG. 2 is a flow diagram of an initialisation process of the sales system;

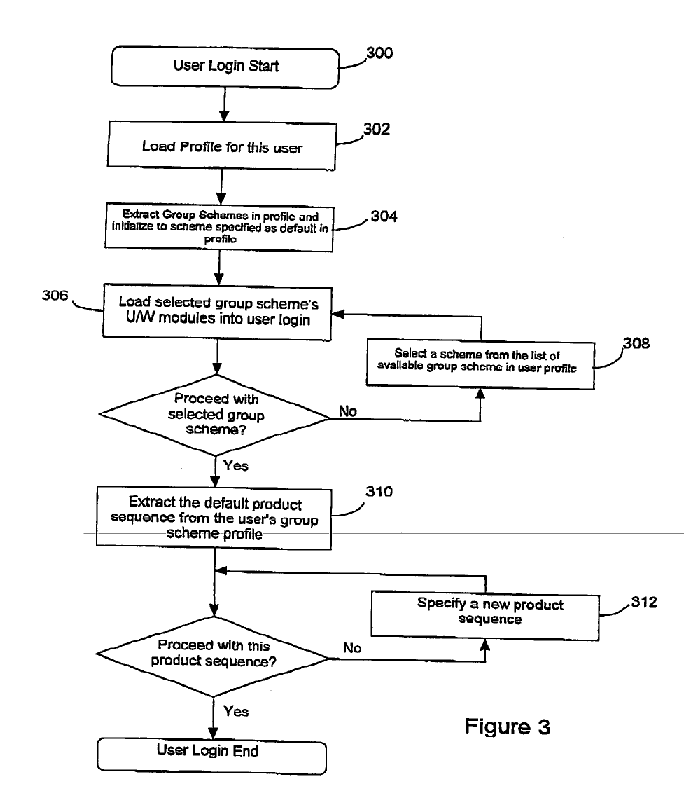

FIG. 3 is a flow diagram of a login process of the sales system;

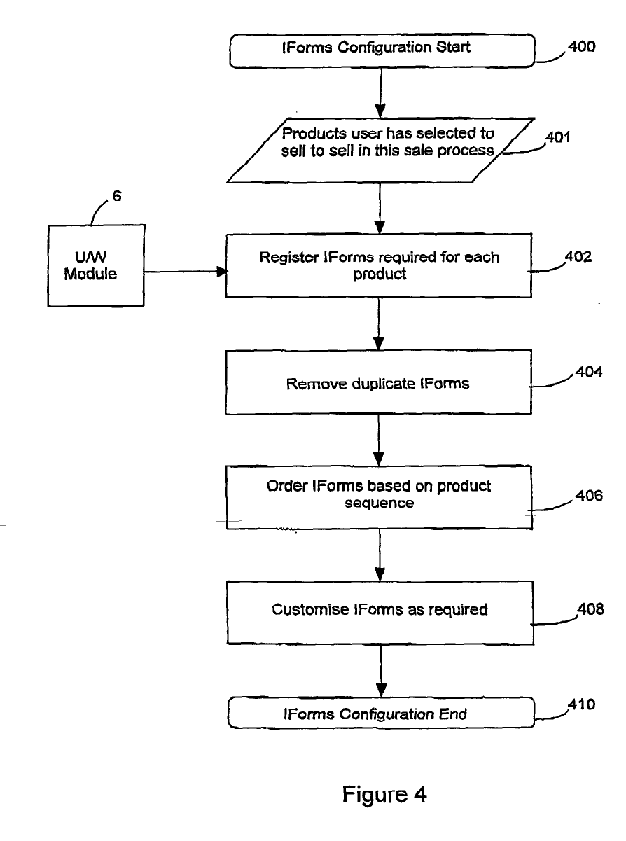

FIG. 4 is a flow diagram of an IForms process of the system;

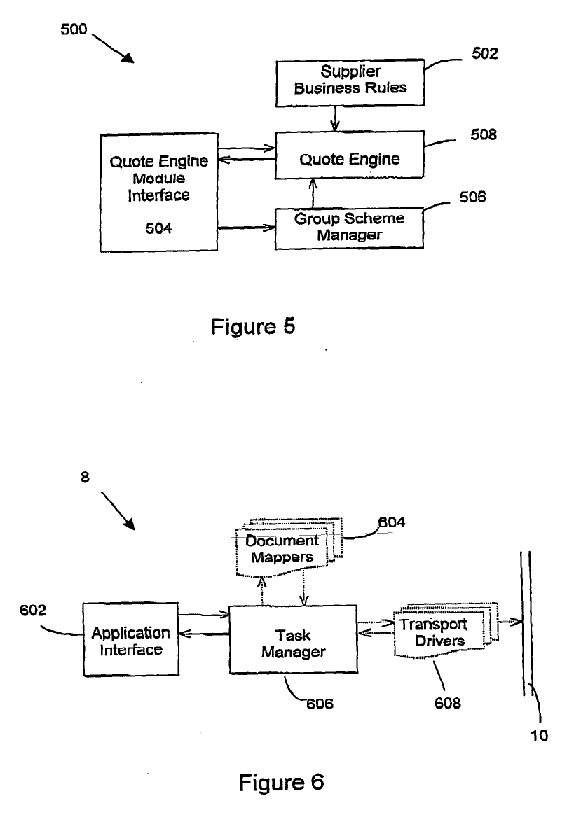

FIG. 5 is a block diagram of the architecture of an underwriting module of the system;

FIG. 6 is a block diagram of a contract and lodgement engine of the system;

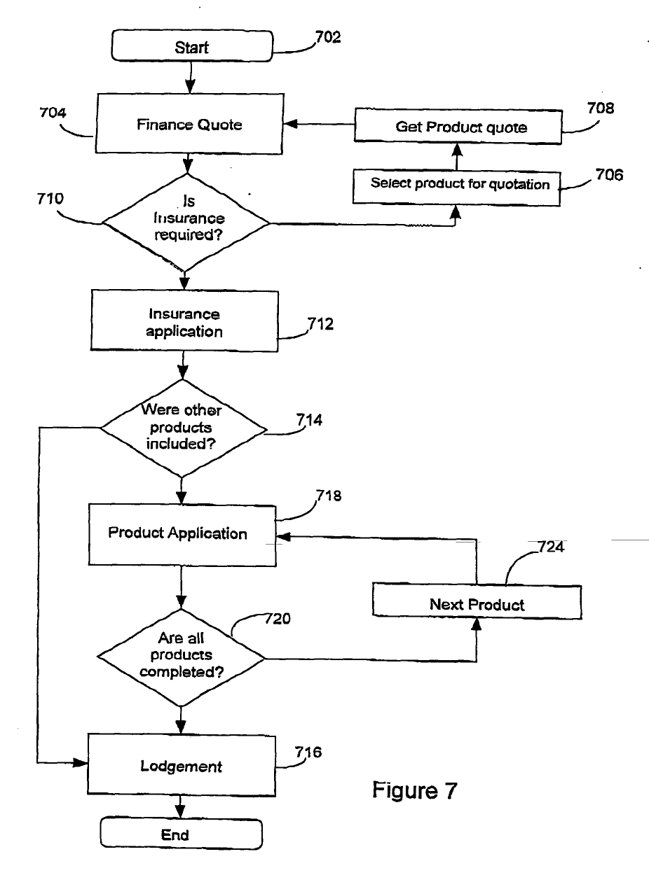

FIG. 7 is a flow diagram of a sales process executed by the system;

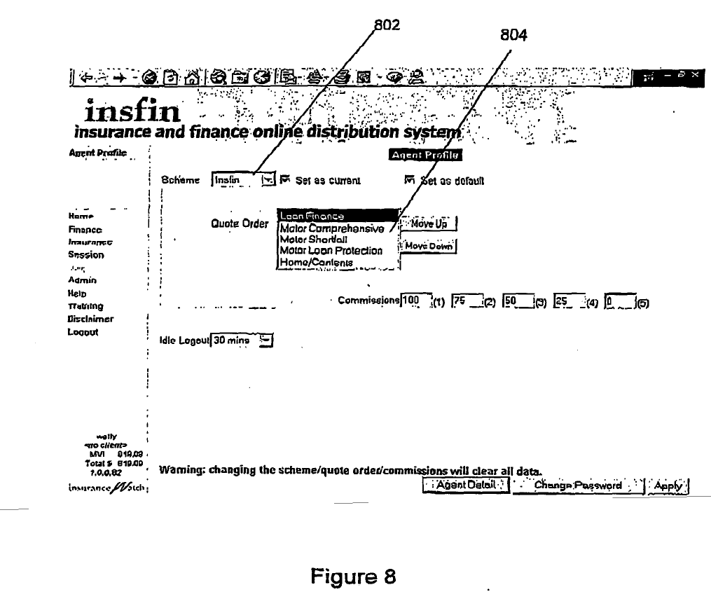

FIG. 8 is a product sequence selection interface of the system;

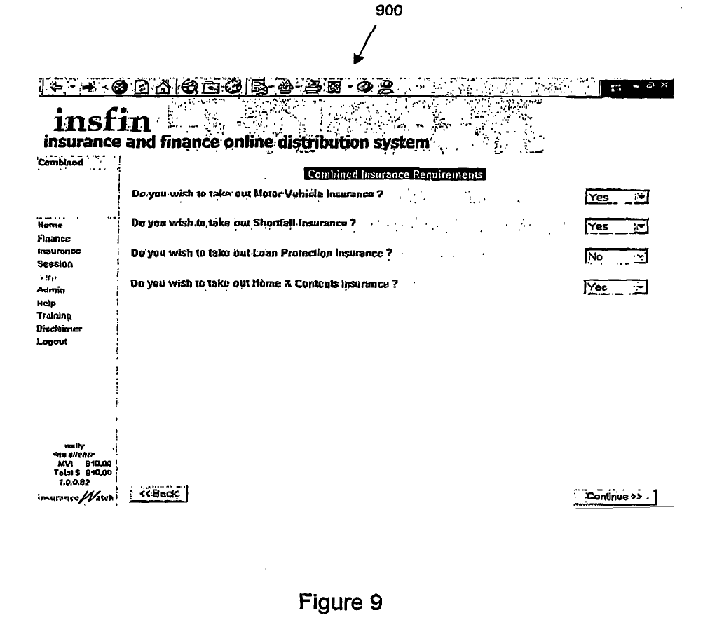

FIG. 9 is a product selection interface of the system:

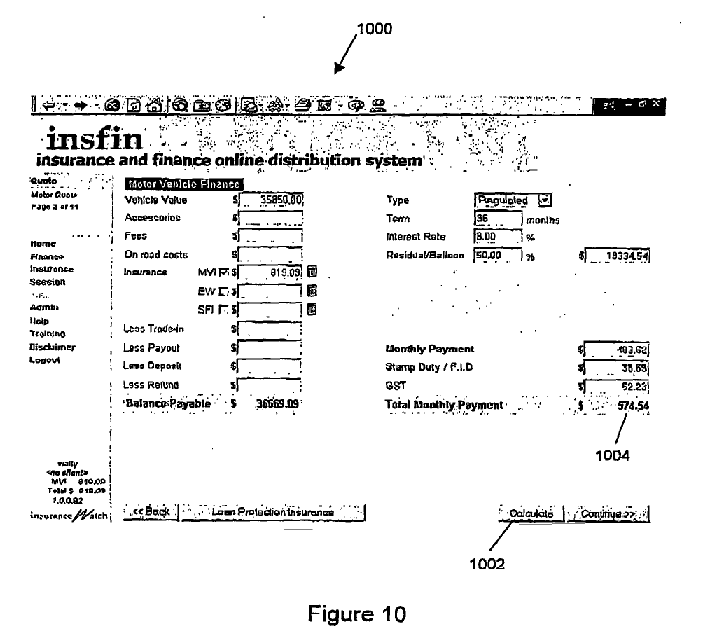

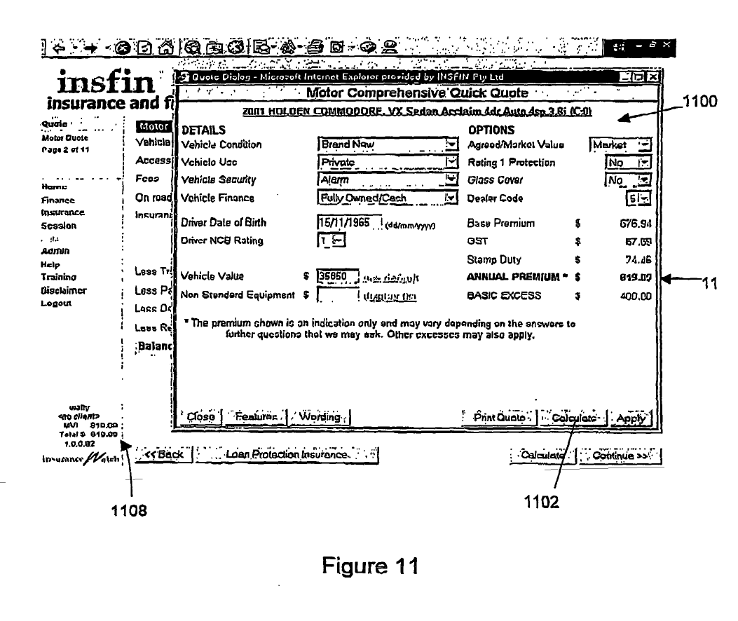

FIG. 10 is a finance quote page generated by the system;

FIG. 11 is an insurance quote page generated with a finance quote page by the system;

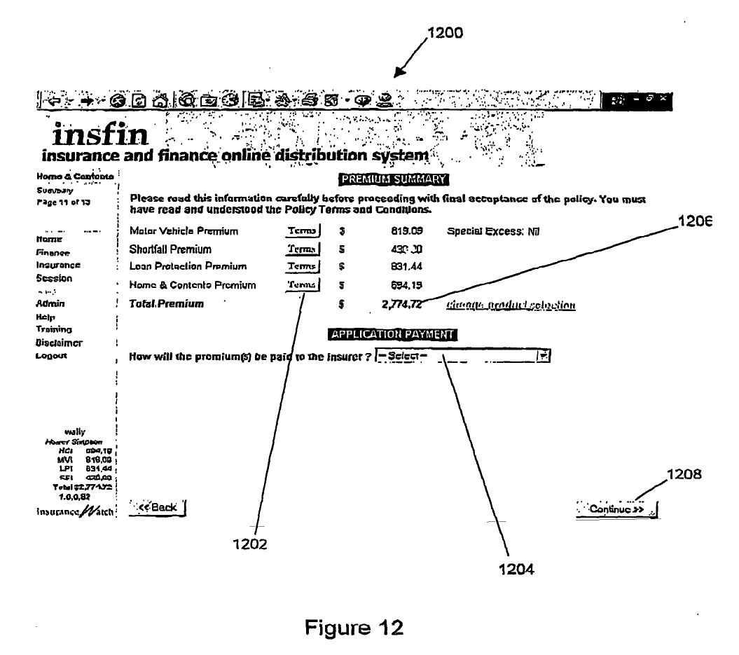

FIG. 12 is a multiple product sales quote page generated by the system; and

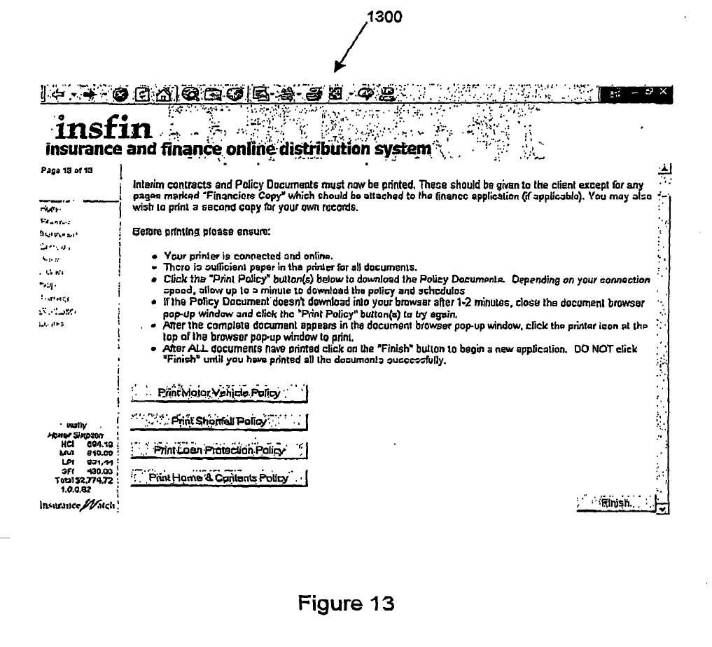

FIG. 13 is a contracts page generated by the system.

A sales computer system 2, as shown in FIG. 1, includes a forms generation (“Iforms”) module 4, underwriting (U/W) modules 6 and a contract and lodgement engine module 8. The modules 4 to 8 are executed on a computer system 2 that is able to communicate with user's systems 16 over a communications network 10. To provide extensive access to users, the system 2 includes a communications interface 12, such as that provided by a web server, to enable communications over the Internet 10. Users are therefore able to log in to and communicate with the system 2 using a standard web browser 14 on a user computer system 16. Similarly the computer system 18 of a product supplier is able to communicate with the sales system 2 over the Internet 10. The system 2 may further include a transaction module 20 for completing electronic funds transfer (EFT) payment transactions with financial institutions over the communications network 10. The modules 4, 6, 8 and 20 enable execution of the sales process described below.

The sales computer system 2 is described below as being implemented on a standard web server system, such as a PC running a Microsoft Windows™ operating system and Microsoft IIS™, with the modules 4, 6, 8 and 20 being software modules developed using a language such as Borland's Delphi™. Each module has an interface that expects to receive data in a prescribed manner. Therefore, modules need not necessarily be programmed in the same language. It will be readily apparent to the addressee that a number of other implementations may be adopted. For example, the processes executed by the modules 4, 6, 8 and 20 may be executed, at least in part, by dedicated hardware circuits. The components or modules of the system 2 may also be distributed over a number of different machines, and may be distributed over a communications network 10, such as the Internet. The preferred implementation however is of course the implementation described below, which is considered to be the most efficient and advantageous.

The sales system 2 approaches the sales process from a client, product purchaser, focus. The system 2 enables a client to engage a user of the system 2, acting as sales intermediary or agent, to purchase a range of products from a number of product suppliers from different industries (including product supplier schemes applying different underwriting and commission structures), in a single streamlined sales process.

The system 2 encapsulates each available product type into a U/W module 6 which shares an intelligent system interface, provided by the IForms module, with all other U/W nodules 6. Each U/W module 6 stores key business rules in a database 502 that can be remotely accessed and electronically updated by a product supplier without programming changes to the relevant U/W module 6. Based on the subset of products selected by the user for a client during a sales session, the IForms module 4 queries the corresponding U/W modules 6 and dynamically constructs the navigation, data entry forms, entry fields, validation processes, and report formats required by each respective product supplier. The Iforms module 4 consolidates the information each U/W module 6 requires to be collected from the client into a series of forms which removes duplication of data entry or data requests, as discussed below. The sequence of data collection is also entirely flexible in response to a preset sequence defined by a user profile. The contract and lodgment engine 8 is used to extract and transmit the sales information required by the suppliers of the products selected by a user in the supplier's preferred format.

The IForms module 4 executes a form generation process to establish a sequence of forms that need to be completed in order to establish a contract for the sale of a selection made from the available products. The selection may comprise one product, but is normally a group of the available products. The sequence of forms generated by the IForms module 4 are used to dynamically generate a sequence of web pages for a user, and allow the user to complete the forms and submit the required data using a browser 14. The IForms module 4 determines the forms required for the selection on the basis of product information obtained from the U/W module 6.

Each of the U/W modules 6 include a structure 500, as described below with reference to FIG. 5, that is able to generate a quote for a product suppliers product using a quote engine 508. The quote engine 508 uses the product supplier's business rules 502 together with data entered by the user to generate a quote for a corresponding product. The structure 500 also provides an interface 504 to other data associated with corresponding products for that module 6, such as information concerning various schemes associated with the products, managed by a group scheme manager 506. A scheme can be considered a collection of products that are offered at adjusted rates using unique branding or promotional techniques. For example, a scheme may comprise a selection of products under the logo of a third party, such as a vehicle manufacturer. A product is defined by the business rules and/or other data stored or accessible by the respective U/W module 6. The scheme manager 506 is able to adjust the business rules and/or data for a product or products of a module 6 so as to apply a selected group scheme, as discussed below. The architecture of the system 2 advantageously allows schemes to be added or changed for products in a short period of time, such as 24 hours.

The contract lodgment engine 8 receives the customer data submitted by users via the forms generated by the IForm module 4, once a product selection has been accepted by the client and sold by the user. The engine 8 maps the submitted client data into a format required by the product supplier and transmits it to the supplier. This provides an opportunity for the supplier to accept the sale of a product selection or to simply receive lodgment of the requisite data following the sale. The engine 8 is able to generate a contract for the sale of the selection and publish that over the communications network 10, for delivery to the user at the browser 14 and for lodgment at the supplier's system 18 to confirm the sale.

Before system startup is commenced, the system 2 must first be initialised. System initialisation includes the steps set out in FIG. 2. Underwriting modules 6 that can be used by the system 2 are registered in a predetermined global registration area (at step 202). All available products are then registered in the global registration area (at step 204). Finally, all available group schemes are registered in the global registration area (at step 206). At system startup, the system 2 queries the global registration area to determine the underwriting modules 6, products and group schemes that are available. Lists 208, 210 and 212 of each of these items are maintained by the system 2 and queried when users login to the system.

In order for a user to use the system 2, the user first subscribes to the system 2. This may be done, for example, by a user contacting a call centre associated with the system and making a formal request to be a member of the system 2. An administrator at the call centre, requests identification information so that he/she can form an account for the user. The system administrator enters these details into the system 2 and the system 2 generates a profile for that user. The user nominates a login name and password and if the user is approved by the administrator and by the system, the user has successfully subscribed to the system 2. Alternatively a user may use the web browser 14 to access a subscription page of the system 2. The subscription page prompts the user for various account and registration details and once these details have been entered, the system 2 prompts the user to nominate a user name and password. The system 2 checks these details and establishes a user profile for that user if their details are in order.

The registration details of each user are stored on a database of the system 2 and these details together with other data stored on the database and on the system's memory are used to populate pages generated by the web server. The collection of pages populated with data pertaining to a registered user form a profile for that user. A user's profile may comprise data held in the database, dynamic page scripts, such as ASP Scripts, or may include additional code to invoke software modules accessible by the user.

Before a user can commence a sales process he/she logs onto the system 2 via their web browser 14 (at step 300). Their login code identifies them in and an audit trail is commenced for transactions and activity. When a valid login is entered the system 2 loads the user's profile (at step 302) and from the profile, the group schemes to which the user is registered are determined. A default group scheme is specified within the user's profile and this scheme is loaded first into the user's login (at step 304)

The user can choose any one of a number of schemes to which they are registered to access (at step 308). These schemes are selected from the list 802 provided on the user's profile, as shown in FIG. 8. When a scheme is selected, the underwriting modules 6 required for that scheme are located by the system 2 using information determined at system startup, as described above. The underwriting modules 6 for the selected scheme are then loaded into the user's login (at step 306).

An underwriting module 6 provides a consistent interface 504 to obtain and check a product suppliers business rules 502 and to dynamically determine quotes as required, as shown in the underwriting module structure 500 of FIG. 5. Each underwriting module 6 provides an interface 504 to general information such as the product supplier's name, the products supported by the underwriting module, current version, selected group scheme etc. The interface 504 is extended for each product type to provide access to the product supplier's business rules 502 and quote engine 508.

The supplier's business rules 502 and quote engine 508 may reside in a local or remote location. That is, the code for the rules 502 and quote engine 508 may be executing on a local server or a remote server using a service provided by the respective product supplier or other parties.

When an underwriting module 6 is loaded for the first time, a user's default group scheme will be selected. The group scheme manager 506 sets the business rules and rates in force for all calculations until the group scheme is changed. As a result of the user only being registered to use specific group schemes, the group scheme selected is usually linked to the client's currently active group scheme.

The users profile also includes a default order of products for a selected group scheme and this information is extracted by the system 2 (at step 310). The user can choose any order in which the selected products appear (at step 312). The order is modified by manipulating the list of products 804 for a group scheme 802 provided on the user's profile, as shown in FIG. 8. As such, the profile also allows the user to configure the system 2 to display sales screens for the products of a group scheme in an order preference aligned to their sales technique. For example, the system 2 can be configured for a particular scheme 802, using an interface as shown in FIG. 8, to ask questions related to finance before questions related to insurance or vice versa depending on the preferred selling technique of the user. The product supplier, who may be an insurer, can also preset the product types that the user can sell so that only those products with which the user is compliant will appear in their profile. The product sequence selection process is complete once the group scheme and the product sequence have been determined.

The IForms module 4 executes an IForms configuration process, as shown in FIG. 4, that commences at step 400. The user causes the system 2 to generate a sales screen 900, as shown in FIG. 9, from their profile. The products are selected by the user for a client at step 401. The IForms module 4 looks through all the products 401 selected by the user and registers (at step 402) the forms stored in the system's memory that are required for the present sales process using the data supplied by the corresponding underwriting modules 6.

Once all the forms required have been determined by the system, the IForms module 4 removes all duplicate forms (at step 404) (such as duplicate forms for client details, addresses, financial information, insurance history etc) and orders the forms (at step 406) based on the product sequence as determined by the user's profile. The process removes all duplicate requests for data contained in the retained forms to prevent duplicate data entry. Finally, any forms requiring customisation are modified (at step 408) before being presented to the client during the sales process.

For example if the client chooses to purchase Motor insurance, a consumer credit product (CCI) and a home insurance policy, the IForms module 4 determine that all three products requested require the client's personal and contact details and therefore only one client details entry form for presentation to the user. Then product specific information is requested for underwriting purposes; for Motor, a form asking for vehicle/driver details is generated, for CCI a form to collect employment details is generated and for Home a form asking for building location, security and construction is generated. This dynamically created set of forms is presented to the user for data entry in an order that corresponds to the user's selected product order.

The user completes each form on behalf of a client. After entry of all details by the user and provided the underwriting requirements are satisfied (as determined by data obtained from the U/W modules 6), a payment form and acceptance is presented by the transaction engine 20.

If the application fails the underwriting questions due to “grey” areas, the system can refer the complete application electronically to a call centre receiver to allow the call centre to offer personalised individual assessment.

Once the application has passed underwriting and payment is satisfied using the transaction engine 20, the system 2 generates the data in the format required by the product supplier's backend administration system and lodges the sale. The contract and lodgement engine 8, as shown in FIG. 6, performs this task which is, generally speaking, the reverse process of the IForms module 4.

The contract and lodgement engine 8 takes the application information and generates separate policy documents for each product. These applications can be transmitted to the appropriate departments within the insurance company or to different insurers altogether. At any time the insurer can reproduce the exact policy document the customer received in a head office, both for current applications and historically for earlier applications.

The contract and lodgment engine 8 is able to format and send documents (such as contracts) to multiple destinations using multiple transport techniques, as shown in FIG. 6. Requests to send one or more documents are received via an application interface 602. The application interface 602 provides a local or remote access point for applications wishing to use the service. A request specifies the prescribed document format and delivery technique.

A document mapper 604 appropriate for the required format is dynamically selected by a task manager 606 and the document is then formatted. The document mapping process may include altering the input document format, structure and file type, the merging of one or more input documents or expanding an input document into multiple output documents.

Once the set of output documents has been generated, the task manager 606 repeatedly selects a transport driver 608 for each destination address and transport mechanism specified and sends the documents until all queued documents have been sent. Responses are gathered from each destination, combined and mapped back into a standard internal format for processing by the requesting application.

Each policy document can be printed using the browser 14 at the point of sale. This removes the need to have preprinted stock of policy information and also provides the product supplier with the ability to change the policy documents being generated in the field in a matter of minutes remotely from a head office.

An example of steps executed by a user when selling products or services to a client is shown in FIG. 7. The user logs into their user profile, selects an appropriate group scheme and selects a suitable product navigation order (at step 702), as described above. The sales process begins when the web server generates a motor vehicle finance page 1000 for tho user (at step 704), as shown in FIG. 10. If no additional products are required, such as insurance (as determined at step 710), the user selects the product for quotation (step 706) and enters the relevant sales information as prompted by the page 1000. The user asks for a product quote (step 708) by executing the “Calculate” function button 1002 provided on the page 1000. The system calculates a finance quote 1004 for the user by interacting with the underwriting modules 6 corresponding to the finance product. The underwriting modules 6 applies the corresponding product supplier's rules 502 and the group scheme rules 506 to clients data and the quote engine 508 corresponding to the underwriting module returns a quote 1004 to the user.

The system 2 also allows the user to sell the client insurance for the motor vehicle (at step 710), the vehicle insurance forms for an insurance application (712) being next in the selected navigation order, by generating an insurance product page 1100 (at step 706), as shown in FIG. 11 in a browser window on top of the finance page window. The user enters the relevant sales information as prompted by the page 1100 and calculates a quote for the client by executing the “Calculate” function button 1102 provided on the page 1100. The system calculates the quote 1108 for the user by interacting with the underwriting module corresponding to the product. The underwriting module applies the corresponding product supplier's rules and the group scheme rules to clients data and the quote engine 508 of the underwriting module returns the quote to the user. As shown in FIGS. 10 and 11, the insurance quote 1108 and quotes for other products can be continually updated in a part of the finance page 1000 on the basis of data entered.

If the selected scheme includes further products to sell the client, as determined at step 714, then the sequence of forms for the next product application is generated and set at step 716. If all of the products in the scheme have not been sold, as selected by the user, this is determined at step 729, then the data for the next product is obtained at step 724 using the corresponding underwriting module 6. Operation then reverts to step 718 to obtain the sequence of forms for the next product. If there are no further products in the scheme for sale, then the system generates a lodgement page 1200 for the user to finalise the sales process (at step 716). The lodgement page 1200 includes the terms 1202 of each sale for the client and includes application payment options for the user 1204. The lodgement page 1200 also includes a total price 1206, a accumulation of each sales quote, for the user. The user concludes the deal by executing the “Continue” function button 1208 on the lodgement page 1200. Upon execution of the “Continue” function button 1208, the system sends all of the user data to the contract and lodgement engine 8 and the sale is completed, as described previously.

Upon successful completion of the above, the system generates an Interim Contracts page 1300 for the user. This page 1300 provides interior contracts for the purchase of goods and interim policies for the purchase of, for example, insurance. These are printable, via the user's web browser 14.

In the example shown in FIGS. 10 to 13, the user has sold the client motor vehicle, shortfall, load protection and home and contents policies in one simple application process.

Many modifications will be apparent to those skilled in the art without departing from the scope of the present invention as described herein with reference to the accompanying drawings.

1. A sales computer system including:
a product selector for offering a plurality of products for sale and receiving a selection of said products; and
a form generator responsive to said selection for accessing data submission forms for the products of said selection, and generating and providing a sequence of forms for said selection.

2. A sales computer system as claimed in claim 1, wherein said form generator removes duplicate data requests from said sequence.

3. A sales computer system as claimed in claim 1, including a cost module responsive to customer data submitted using said sequence for generating a cost for said selection.

4. A sales computer system as claimed in claim 3, wherein said cost module generates a quote for each product of said selection and updates said cost as said customer data is submitted using said sequence.

5. A sales computer system as claimed in claim 3, including a contract engine for generating, on the basis of the customer data, and facilitating execution of a contract for sale of said selection at said cost.

6. A sales computer system as claimed in claim 5, including a transaction engine for executing a payment transaction to obtain payment for said cost.

7. A sales computer system as claimed in claim 5, wherein said contract engine publishes said contract for a client and lodges said contract for a product supplier.

8. A sales computer system as claimed in claim 3, including a plurality of said cost module for respective sets of one or more products having access to business rules and/or data for said sets.

9. A sales computer system as claimed in claim 8, wherein said cost module includes an interface for said product selector.

10. A sales computer system as claimed in claim 8, wherein said cost module includes an interface for said form generator.

11. A sales computer system as claimed in claim 3 or 8, including a scheme manager for adjusting business rules and/or data for said products to provide a predetermined sale scheme that is applied to said sequence.

12. A sales process, executed by a computer system, including:
offering a plurality of products for sale;
receiving a selection of said products;
accessing data submission forms for products of said selection;
removing duplicate data requests from said forms; and
generating and providing a sequence of forms for said selection.

13. A sales process as claimed in claim 12, including receiving customer data submitted using said sequence, and generating a cost for said selection on the basis of said customer data.

14. A sales process as claimed in claim 13, including facilitating execution of the contract, generated on the basis of said customer data, for sale of said selection at said cost.

15. A sales process as claimed in claim 14, including generating a quote for each product of said selection and updating said cost as said customer data is submitted using said sequence.

16. A sales process, executed by a computer system, including:
dynamically generating a sequence of data submission forms for sale of a selection of different products, such as insurance and finance products, said sequence excluding duplicate data entry requests;
dynamically generating a quote for the products of said selection on submission of the forms of said sequence; and
dynamically generating and publishing at least one contract for sale of said products on acceptance of said quote.

17. A sales process, executed by a computer system, for sale of different products, including:
selecting said products;
querying underwriting modules for the products to obtain corresponding business rules;
dynamically constructing client data submission forms for sale of said products on the basis of data from said underwriting modules, said forms removing duplication of data entry;
providing said forms in a sequence based on a user profile; and
extracting and transmitting client data submitted using said sequence to different suppliers of the products in respective formats for the suppliers.

18. A sales process as claimed in claim 17, wherein said suppliers are from different industries, such as insurance and finance industries.

19. A sales process as claimed in claim 17 or 18, wherein said underwriting modules are adapted to apply different product supplier schemes having different underwriting and commission structures to said business rules.

20. A sales computer system including:
a form generator responsive to the selection of products for sale for accessing data submission forms for the products of said selection, and generating and providing a sequence of forms for the selection;
a cost module responsive to customer data submitted using said sequence for generating a cost for the selection; and
a scheme module for applying a predetermined sales scheme to said sequence and said cost.

21. A sales computer system as claimed in any one of claims 1 to 11 and 21, wherein said products include insurance and financial products.

22. A sales process as claimed in any one of claims 12 to 19, wherein said products include insurance and financial products.

23. A sales system having components for executing the steps of a sales process as claimed in any one of claims 12 to 19.

24. Software modules stored on computer readable storage, and having code for executing the steps of a sales process as claimed in any one of claims 12 to 19.
